(19) United States
(12) Patent Application Publication
(10) Pub. No.: US 2024/0064106 A1
(43) Pub. Date: Feb. 22, 2024

(54) METHODS AND SYSTEMS FOR FLOW-BASED TRAFFIC CATEGORIZATION FOR DEVICE OPTIMIZATION

(71) Applicant: QUALCOMM Incorporated, San Diego, CA (US)

(72) Inventors: Marcelo SCHIOCCHET, San Diego, CA (US); Ayman Tharwat ABDELHAMID, San Diego, CA (US); Kausik RAY CHAUDHURI, San Diego, CA (US); Supratik BHATTACHARJEE, San Diego, CA (US); Gautham HARIHARAN, Sunnyvale, CA (US)

(21) Appl. No.: 17/820,869

(22) Filed: Aug. 18, 2022

(51) Int. Cl. H04L 47/2475; H04L 41/16; H04W 28/02

(52) U.S. Cl. CPC H04L 47/2475; H04L 41/16; H04W 28/0284

(57) ABSTRACT

A user equipment may be configured to implement a procedure for employing flow-based traffic categorization for device optimization. In some aspects, the UE may monitor application traffic of one or more applications installed on the UE, and determine one or more observation features of the application traffic within an observation period. Further, the user equipment may predict, via a machine learning model, a traffic category of the observation period based on the one or more observation features, and apply an optimization to second application traffic of the one or more applications at the UE based on the traffic category.

### BACKGROUND

### Technical Field

The present disclosure relates generally to wireless communication, and more particularly, implementing a procedure for employing flow-based traffic categorization for device optimization (e.g., modem optimization).

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (such as with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example implementation includes a method of wireless communication at a user equipment (UE) comprising monitoring application traffic of one or more applications installed on the UE; determining one or more observation features of the application traffic within an observation period; predicting, via a machine learning model, a traffic category of the observation period based on the one or more observation features; and applying an optimization to second application traffic of the one or more applications at the UE based on the traffic category.

The disclosure also provides a UE including a memory storing computer-executable instructions and at least one processor configured to execute the computer-executable instructions to monitor application traffic of one or more applications installed on the UE; determine one or more observation features of the application traffic within an observation period; predict, via a machine learning model, a traffic category of the observation period based on the one or more observation features; and apply an optimization to second application traffic of the one or more applications at the UE based on the traffic category. In addition, the disclosure also provides an apparatus including means for performing the above method, and a non-transitory computer-readable medium storing computer-executable instructions for performing the above method.

To the accomplishment of the foregoing and related ends, the one or more aspects include the features hereinafter fully described and particularly pointed out in the claims. The following description and the annexed drawings set forth in detail some illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network, in accordance with some aspects of the present disclosure.

FIG. 2A is a diagram illustrating an example of a first 5G/NR frame, in accordance with some aspects of the present disclosure.

FIG. 2B is a diagram illustrating an example of DL channels within a 5G/NR subframe, in accordance with some aspects of the present disclosure.

FIG. 2C is a diagram illustrating an example of a second 5G/NR frame, in accordance with some aspects of the present disclosure.

FIG. 2D is a diagram illustrating an example of UL channels within a 5G/NR subframe, in accordance with some aspects of the present disclosure.

FIG. 3 is a diagram illustrating an example of a base station and a UE in an access network, in accordance with some aspects of the present disclosure.

FIG. 4 is a diagram illustrating an example disaggregated base station architecture, in accordance with some aspects of the present disclosure.

FIG. 5 is a diagram illustrating an example of communications of a network entities and devices, in accordance with some aspects of the present disclosure.

FIG. 6 is a diagram illustrating an example of application traffic collection, in accordance with some aspects of the present disclosure.

FIG. 7 is a diagram illustrating an example of throughput bursts within observation periods, in accordance with some aspects of the present disclosure.

FIG. 8 is a diagram illustrating an example of throughput burst gaps within observation periods, in accordance with some aspects of the present disclosure.

FIG. 9 is a diagram illustrating an example of qualified throughput bursts within observation periods, in accordance with some aspects of the present disclosure.

FIG. 10 is a bar graph illustrating an example of one or more features downselected based on feature importance, in accordance with some aspects of the present disclosure.

FIG. 11 is a diagram illustrating an example of a hardware implementation for a UE employing a processing system, in accordance with some aspects of the present disclosure.

FIG. 12 is a diagram illustrating an example of a hardware implementation for a network entity employing a processing system, in accordance with some aspects of the present disclosure.

FIG. 13 is a flowchart of an example method of flow-based traffic categorization for device optimization, in accordance with some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to a person having ordinary skill in the art that these concepts may be practiced without these specific details. In some instances, structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, among other examples (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, among other examples, whether referred to as software, firmware, middleware, microcode, hardware description language, or otherwise.

Accordingly, in one or more examples, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Various implementations relate generally to a procedure for employing flow-based traffic categorization for device optimization (e.g., modem optimization). Many operations performed by a UE are configured for optimal performance across various applications and use cases. For example, modems employed by UEs are often designed to support high data rates and low latency while providing excellent reception and transmission characteristics. Further, without information regarding the performance requirements of different use cases, a UE needs to be ready to operate in high a performance mode, which may cause various types of waste. For example, a UE may inefficiently consume power due to intensive measurements, frequent control channel monitoring, missed discontinuous reception (DRX) opportunities, and unnecessarily large bandwidth monitoring. Conversely, if traditional techniques for waste reduction are applied without knowledge of device context (e.g., active applications, use case, etc.), it is possible that the performance requirements of the use case are not met thereby causing poor user experience.

As such, in some aspects, a UE may be configured to optimize performance based on flow-based traffic categorization. As described in detail herein, a UE may employ a machine learning component to predict the type of traffic transmitted and received based on the traffic flow at the UE. In addition, the UE may employ one or more pre-configured optimization techniques based on the predicted type of UE traffic. Some examples of traffic types include Some examples types of traffic include video streaming, non-video streaming, audio calling, non-audio calling, text messaging, media downloading, media uploading, and gaming traffic. For example, a UE may reduce power consumption by disabling one or more antenna elements to generate a narrower beam without negatively impacted UE performance in view of predicted type of traffic. Accordingly, in some aspects, once a certain use case is identified, a pre-determined optimization technique may be triggered in order to adjust the UE performance level to best match the traffic category type and reduce unnecessary waste (e.g., unnecessary power consumption). Further, by adopting a flow-based approach as opposed to an approach based on a system API, the present invention is not limited to use cases that transmit and send unencrypted data or use cases with known applications, and does not require packet inspection which may be resource intensive and intrusive.

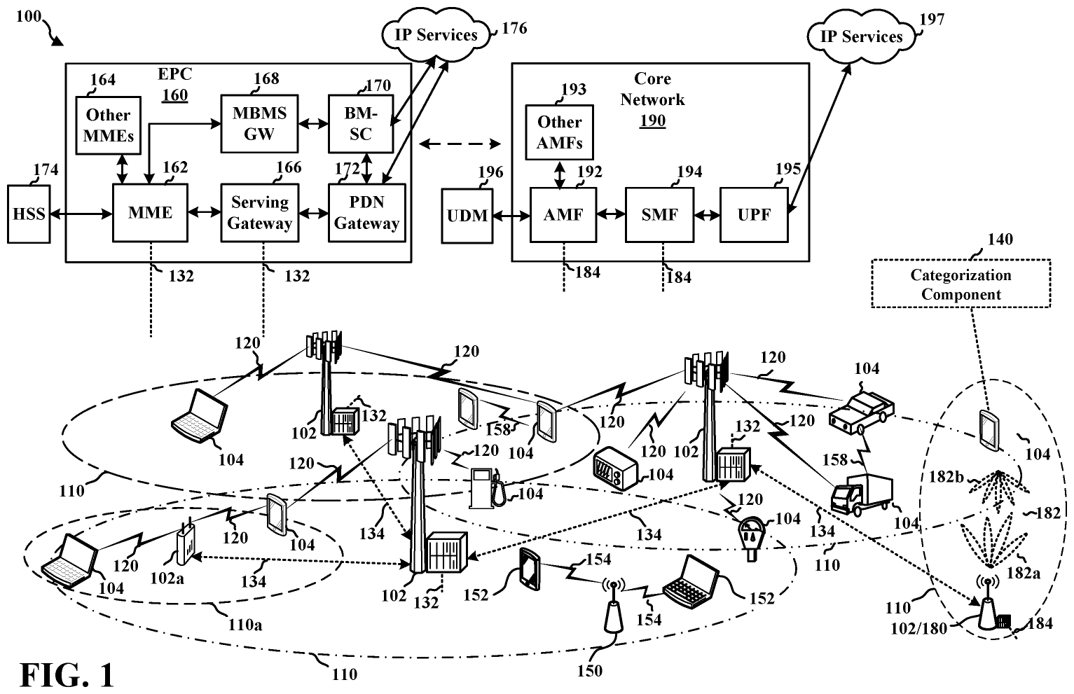

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (for example, a 5G Core (5GC)). The base stations 102 may include macrocells (high power cellular base station) or small cells (low power cellular base station). The macrocells include base stations. The small cells include femtocells, picocells, and microcells.

In an aspect, a UE 104 may include a categorization component 140 configured to determine the type of application traffic at the UE 104 and optimize device operation at the UE 104 based on the type of application traffic. As described in detail herein, in some examples, device optimization may include modifying modem function to reduce power consumption with reduced affects on device performance.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (for example, an S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (for example, handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (for example, through the EPC 160 or core network 190) with each other over third backhaul links 134 (for example, X2 interface). The third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102a may have a coverage area 110a that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 or downlink (DL) (also referred to as forward link) transmissions from a base station 102 to a UE 104. The communication links 120 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (for example, 5, 10, 15, 20, 100, 400 MHz, among other examples) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (for example, more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Some UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102a may operate in a licensed or an unlicensed frequency spectrum. When operating in an unlicensed frequency spectrum, the small cell 102a may employ NR and use the same 5 GHz unlicensed frequency spectrum as used by the Wi-Fi AP 150. The small cell 102a, employing NR in an unlicensed frequency spectrum, may boost coverage to or increase capacity of the access network.

A base station 102, whether a small cell 102a or a large cell (for example, macro base station), may include or be referred to as an eNB, gNodeB (gNB), or another type of base station. Some base stations, such as gNB 180 may operate in one or more frequency bands within the electromagnetic spectrum. The electromagnetic spectrum is often subdivided, based on frequency/wavelength, into various classes, bands, channels, etc. In 5G NR two initial operating bands have been identified as frequency range designations FR1 (416 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range. The base station 180 and the UE 104 may each include a plurality of antennas, such as antenna elements, antenna panels, or antenna arrays to facilitate the beamforming.

The base station 180 may transmit a beamformed signal to the UE 104 in one or more transmit directions 182a. The UE 104 may receive the beamformed signal from the base station 180 in one or more receive directions 182b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, or other IP services.

The base station may include or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a satellite phone, a cellular phone, a smart phone, a session initiation protocol (SIP) phone, a laptop, a personal digital assistant (PDA), a satellite radio, a global positioning system, a multimedia device, a video device, a digital audio player (for example, MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (for example, parking meter, gas pump, toaster, vehicles, heart monitor, among other examples). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 5G NR, the concepts described herein may be applicable to other similar areas, such as LTE, LTE-A, CDMA, GSM, and other wireless technologies.

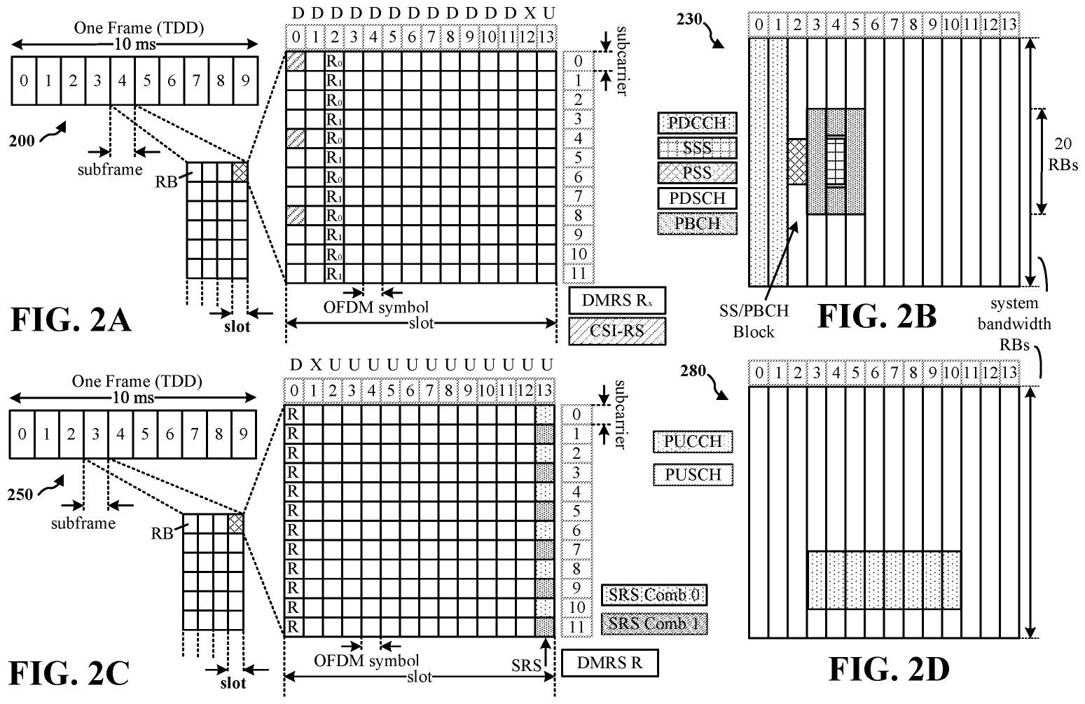

FIGS. 2A-2D include example diagrams 200, 230, 250, and 280 illustrating examples structures that may be used for wireless communication by the base station 102 and the UE 104, e.g., for 5G NR communication. FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description presented herein applies also to a 5G/NR frame structure that is TDD.

Other wireless communication technologies may have a different frame structure or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. For slot configuration 0 and numerology μ, there are 14 symbols/slot and 2μ slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more CCE, each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), or UCI.

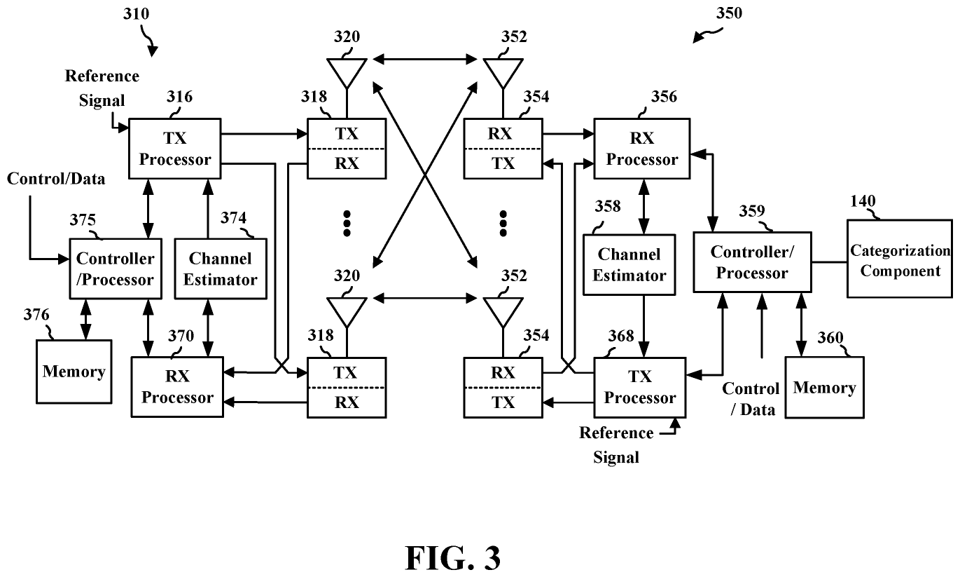

FIG. 3 is a block diagram of a base station 102/180 in communication with a UE 104 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (such as MIB, SIBs), RRC connection control (such as RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (such as binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (such as a pilot) in the time or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK or NACK protocol to support HARQ operations.

Similar to the functionality described in connection with the DL transmission by the base station 102/180, the controller/processor 359 provides RRC layer functionality associated with system information (for example, MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK or NACK protocol to support HARQ operations.

In the UE 104, at least one of the TX processor 368, the RX processor 356, and the controller/processor 359 may be configured to perform aspects in connection with the categorization component 140 of FIG. 1.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

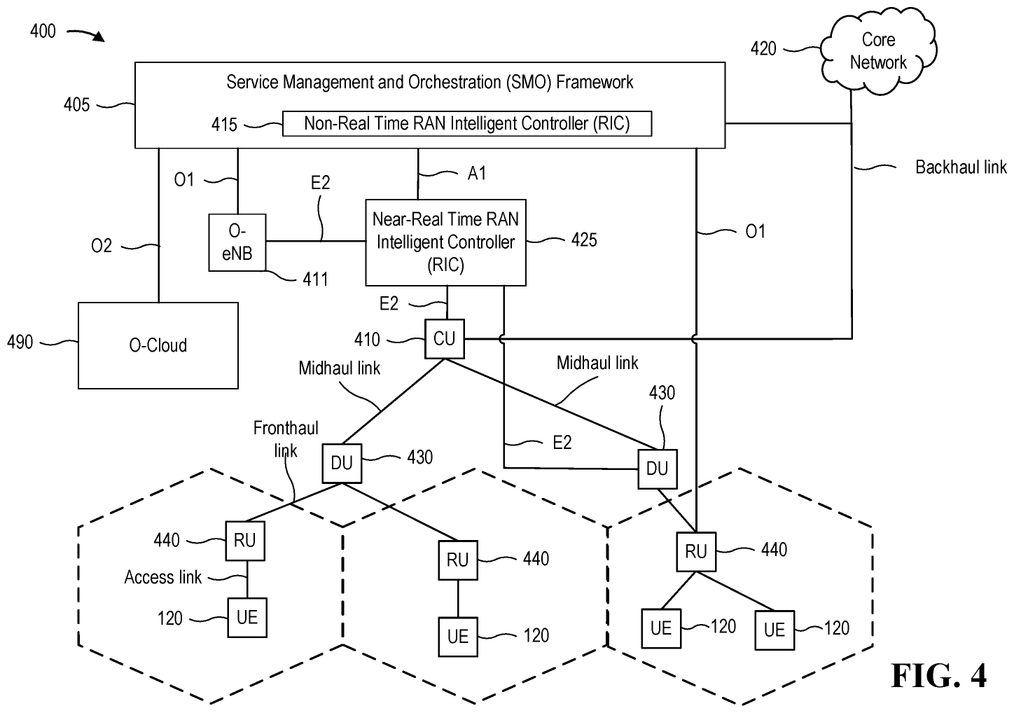

FIG. 4 shows a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUs 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit—User Plane (CU-UP)), control plane functionality (i.e., Central Unit—Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

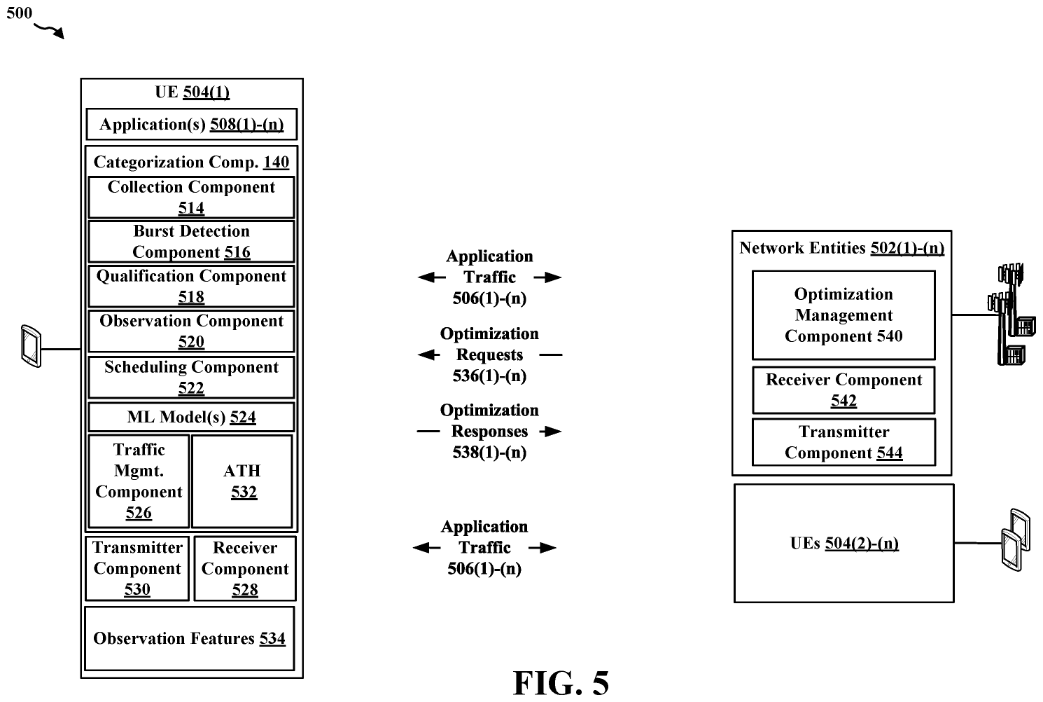

Referring to FIGS. 5-13, in one non-limiting aspect, a system 500 is configured to implement a procedure for flow-based traffic categorization for device optimization, in accordance with some aspects of the present disclosure.

FIG. 5 is a diagram illustrating example communications and components of network entities and devices. As illustrated in FIG. 5, the system 500 may include one or more network entities 502(1)-(n) (e.g., the base station 102/180) and one or more UEs 504(1)-(n) (e.g., the UEs 104). Further, in some aspects, the network entities 502(1)-(n) may serve the UEs 504(1)-(n). The UEs 504(1)-(n) may also communicate with each other over via a sidelink.

As illustrated in FIG. 5, the UE 504(1) may include a categorization component 140 configured to categorize application traffic 506(1)-(n) and optimize operations at the UE 504(1) based on the categorization. For example, the UE 504(1) may transmit and receive application traffic 506(1)-(n) associated with one or more applications 508(1)-(n) installed on the UE 504(1). The application traffic 506(1)-(n) may be transmitted to the network entities 502(1)-(n) and other UEs 504(2)-(n), and/or received from the network entities 502(1)-(n) and other UEs 504(2)-(n). Further, the categorization component 140 may average the application traffic 506(1)-(n) in the time domain, and detect one or more throughput bursts within the averaged data. In addition, the categorization component 140 may determine one or more observation features based on the throughput bursts, and categorize the application traffic 506(1)-(n) based on the observation features. As described in detail herein, in some aspects, the categorization component 140 may perform machine learning and/or other pattern recognition techniques to predict a category of the application traffic 506(1)-(n) based on the observation features. Some examples of the observation features include throughput bursts per minute, throughput burst occupancy, throughput burst volume percentage, throughput burst volume standard deviation, throughput burst gap standard deviation, or downlink volume ratio. Upon determining the category of the application traffic 506(1)-(n), the categorization component 140 may identify one or more optimizations associated with the category. In addition, the categorization component 140 may apply the one or more optimizations to transmission or reception of the application traffic 506(1)-(n) at the UE 504.

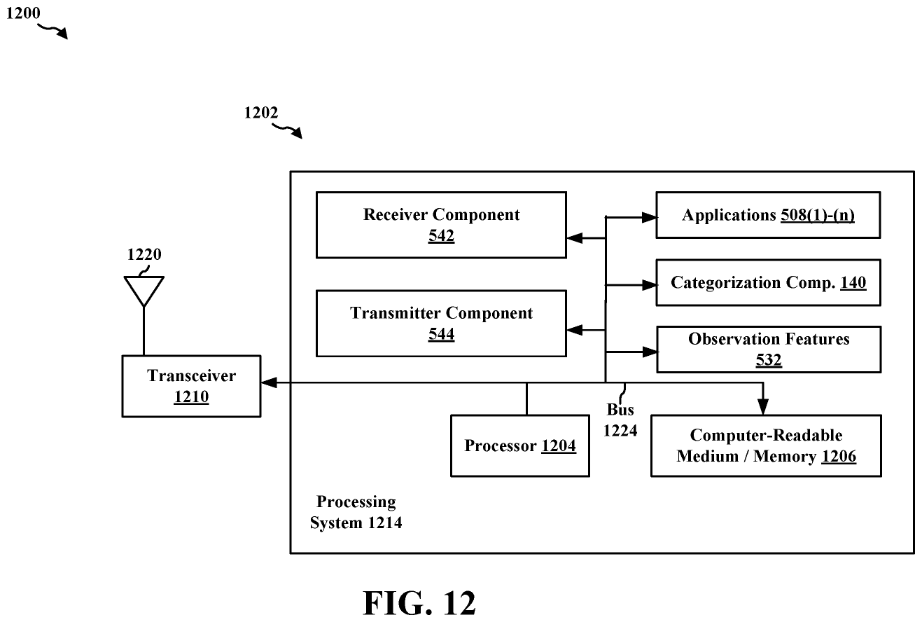

As illustrated in FIG. 5, the categorization component 140 may include a collection component 514, a burst detection component 516, a qualification component 518, an observation component 520, a scheduling component 522, one or more ML models 524(1)-(n), and a traffic management component 526. Additionally, the UE 504(1) may include a receiver component 528, and a transmitter component 530. The receiver component 528 may include, for example, a RF receiver for receiving the signals described herein. The transmitter component 530 may be configured to generate signals for transmission operations as described herein. The transmitter component 530 may include, for example, a RF transmitter for transmitting the signals described herein. In an aspect, the receiver component 528 and the transmitter component 530 may be co-located in a transceiver (e.g., the transceiver 1210 shown in FIG. 12).

The collection component 514 may collect the application traffic 506(1)-(n) and store the application traffic 106(1)-(n) as application traffic history (ATH) 532. In some examples, the collection component 514 may collect the application 506(1)-(n) traffic from a PDCP layer of the UE 504(1). Additionally, or alternatively, the collection component 514 may collect the application traffic 506(1)-(n) from another layer 2 protocol, an internet protocol layer, and/or another layer or protocol of the UE 504(1). Further, in some examples, the collection component 514 may periodically average the application traffic 106(1)-(n) stored as individual application traffic histories 532 to minimize storage use and minimize processing requirements of the categorization process. In addition, in some examples, the collection component 514 may store the application traffic history 532 within a circular history buffer. As described herein, a circular buffer may refer to a data structure that employs a fixed sized FIFO buffer as if it were connected end-to-end.

The scheduling component 522 may trigger prediction of a type of the application traffic 506 currently being transmitted and/or received by the UE. In some aspects, the scheduling component 522 may periodically trigger the categorization component 140 to predict a traffic type of the application traffic 506 in accordance with a predefined schedule.

The burst detection component 516 may detect throughput bursts within the application traffic history 532. As described in detail herein, a “throughput burst” may refer to a period of time in which the throughput of the application traffic is above a threshold amount. In some aspects, the burst detection component 516 may detect throughput bursts within one or more observation periods using multiple detection observation window sizes (i.e., average windows) and throughput burst thresholds. In some aspects, the observation window sizes may be 5 ms, 20 ms, 50 ms, 100 ms, and/or 300 ms. Further, the observation window sizes may be selected based upon the attributes of the one or more ML models 524. Further, in some aspects, the burst thresholds may be percentages of the scheduled throughput, e.g., 10%, 25%, 40%, 80%, 120%, and/or 200% of the scheduled throughput. In some aspects, the schedule throughput may be equal to the average throughput divided by a duty cycle. Further, the burst thresholds may be selected based upon the attributes of the one or more ML models 524.

In particular, the burst detection component 516 may employ a plurality of observation window size and burst threshold pairs to determine the presence of throughput bursts within a single observation period. For each observation window size-burst threshold pair, the burst detection component 516 may divide the observation period into observation windows each having the size of the observation window size of the observation window size-burst threshold pair. Further, the burst detection component 516 may determine that a throughput burst occurs within an observation window when the throughput within the observation window is greater than the burst threshold of the observation window size-burst threshold pair.

The qualification component 518 may qualify an observation period for use in a training phase and/or an inference phase of the one or more ML models 524(1)-(n). For example, if an observation period is qualified, the observation period may be used to categorize the application traffic 506 of the UE 504(1). In some examples, the qualification component 518 may determine whether an observation period is qualified based at least in part on one or more attributes of the application traffic 506 during the observation period. For instance, if the qualification component 518 determines that the application traffic history 532 corresponding to an observation period has a minimum throughput burst greater than a predefined threshold (e.g., 250 kbps) and/or has a minimum burst per minute greater than a predefined threshold (e.g., 2 throughput burst per minute), the qualification component 518 may flag the observation period as qualified.

The observation component 520 may determine one or more observation features 534(1)-(n) for the observation periods. For example, the observation component 520 may determine the observation features 534(1)-(n) of an observation period identified as a qualified observation period by the qualification component 518. In some examples, the observation features 534(1)-(n) may include throughput bursts per minute, throughput burst occupancy, throughput burst volume percentage, throughput burst volume standard deviation, throughput burst gap standard deviation, and/or downlink volume ratio.

The throughput bursts per minute may refer to amount of throughput bursts within an observation window over a predefined period of time (e.g., a minute). The throughput burst occupancy may refer to may refer to the percentage of an observation period that is occupied by throughput bursts. The throughput burst volume percentage may refer to the percentage of total traffic of an observation period that is transmitted with throughput bursts. The throughput burst volume standard deviation may identify the variations throughput volume across throughput bursts. The throughput burst gap standard deviation may identify the variance in the intervals between consecutive throughput bursts. The downlink volume ratio may refer to percentage of application traffic within the observation window that is downlink traffic.

Burst volume standard deviation (normalized) may be defined as follows:

$$\frac{1}{u} \sqrt{\frac{\sum {( xi - u )}^{2}}{N}} \qquad ( Equation 1 )$$

Where xᵢ=data volume in burst (i), u=average volume in each burst, N=number of bursts.

Burst volume standard deviation (non-normalized) may be defined as follows:

$$\sqrt{\frac{\sum {( xi - u )}^{2}}{N}} \qquad ( Equation 2 )$$

Where xᵢ=time gap between burst pairs (i), u=average gap duration, N=number of gaps.

Further, the observation component 520 may determine the observation features 534 for each of the plurality of observation window size and burst threshold pairs selected to perform categorization. In some aspects, larger observation window sizes may eliminate scheduling gaps that appear in large bursts, while smaller observation window sizes may assist in identifying throughput bursts in faster applications (e.g., voice calls). Further, in some aspects, different burst thresholds may more accurately identify certain categories of application traffic.

The one or more ML models 524(1)-(n) may include at least one inference ML model 524(1) configured to categorize the application data traffic based on the observation features 534(1)-(n) determined for the different plurality of observation window size and burst threshold pairs during an inference phase. In some aspects, the observation features 524 may be input to the inference ML model 524 as two-dimensional feature maps having a first observation feature as the first dimension and a second observation as the second dimension. For example, if the observation features 534 include at least throughput bursts per minute, throughput burst occupancy, and throughput burst volume percentage, the inference ML model 524 may receive a first two-dimensional feature map having throughput bursts per minute on the x-axis and throughput burst occupancy on the y-axis, a second two-dimensional feature map having throughput burst occupancy on the x-axis and throughput burst volume percentage on the y-axis, and a third two-dimensional feature map having throughput bursts per minute on the x-axis and throughput burst volume percentage on the y-axis. Further, the ML model 524(1) may receive the observation features 534(1) for the observation period as the three feature maps, and predict the type of traffic of the application traffic 506 based on the observation features 534(1). Some examples of the types of application traffic 506 include video streaming, non-video streaming, audio calling, non-audio calling, text messaging, media downloading, media uploading, and gaming traffic. Further, in some aspects, the categorization may further include a predicted application and/or type of application associated with the traffic. For example, the inference ML model 524(1) may categorize the application traffic during an observation window as video streaming traffic associated with a browser of the UE 504(1). Some examples of the one or more ML models 524(1)-(n) may be a include a neural network or another type of machine learning model, e.g., an autoencoder. In some aspects, a “neural network” may refer to a mathematical structure taking an object as input and producing another object as output through a set of linear and non-linear operations called layers. Such structures may have parameters which may be tuned through a learning phase to produce a particular output, and are, for instance, used for audio synthesis. In addition, the ML models 524 may be a model capable of being used on a plurality of different devices having differing processing and memory capabilities. Further, in some aspects, the ML model 104 may include a 1-dimensional convolutional neural network or a 1-dimensional autoencoder.

Additionally, the one or more ML models 524 may include at least one feature selection ML model 524(2) configured to identify the determinative observation features in a training phase and downselect the observation features and plurality of observation window size and burst threshold pairs to be employed during the inference phase. For example, the feature selection ML model 524(2) may determine that only the throughput burst volume percentage, throughput burst volume standard deviation, throughput burst gap standard deviation observations features are needed using a first pair (e.g., 5 ms observation window size and 80% burst threshold) and a second pair (e.g., 20 ms observation window size and 100% burst threshold).

The traffic management component 526 may modify the operation of the UE 504(1) based on the category predicted by the inference ML model 524(1). For example, the inference ML model 524 may determine the application traffic is streaming video, and the traffic management component 526 may optimize operation of the UE 504(1) for video streaming traffic.

Further, in some aspects, the traffic management component 526 may modify the operation of the UE 504(1) based on optimization requests 536(1)-(n) and optimization responses 538(1)-(n). For example, the UE 504(1) may transmit an optimization request 536(1) to the network entity 502(1). The optimization request 536 may identify the category of the application traffic 506 as predicted by the inference ML model and/or a requested optimization in view of the categorization of the application traffic as determined by the inference ML model 524(1). Further, in response to the optimization request 536(1), the network entity 502(1) may transmit an optimization response 538(1) to the UE 504(1) based on the optimization request 536(1). The optimization response 538 may approve the optimization request and/or indicate that the UE 504(1) should apply one or more particular optimizations in view of categorization of the application traffic.

Some examples of optimizations include network configuration changes, schedule coordination, system specific optimization modes, and/or custom modes of particular protocols. For instance, the UE 504(1) may request modification to one or more dynamic connected mode discontinuous reception (CDRX) parameters to reduce power consumption. In some aspects, each CDRX cycle may include a sleep period and an awake period. Further, the duration of the sleep period may vary based upon whether the CDRX is configured to perform a short CDRX cycle or long CDRX cycle. In particular, the sleep period for the short CDRX cycle may have a duration that is shorter than the sleep period of the long CDRX cycle.

Additionally, or alternatively, the UE 504(1) may optimize for the identified traffic category by requesting optimization of bandwidth parameters (e.g., maxBW-Preference-r16), component carrier parameters (e.g., maxCC-Preference-r16), multiple-input and multiple-output parameters (e.g., maxMIMO-LayerPreference-r16), and/or scheduling parameters (e.g., minSchedulingOffsetPreference-r16). Further, the UE 504(1) may optimize the maximum number of transmit antennas. Additionally, or alternatively, the UE 504(1) may optimize for the identified traffic category by applying at least one of a low latency mode, caching and downlink resource sharing optimization framework (CSF) for low block-error rate (BLER), UL traffic prioritization, reducing the internal processors or DSP clock speed, and/or modifications to transmit power across multiple antenna groups. Additionally, or alternatively, the UE 504(1) may optimize for the identified traffic category by applying custom modes for at least one of a carrier aggregation (CA), bandwidth parts (BWP), and/or MIMO.

As illustrated in FIG. 5, the network entity 502 may include an optimization management component 540 for receiving optimization requests 536(1)-(n) and transmitting optimization responses 538(1)-(n). Further, in some aspects, optimization management component 540 may determine whether to permit the optimization requests 536(1)-(n) and/or update network operations based on the optimization requests 536(1)-(n).

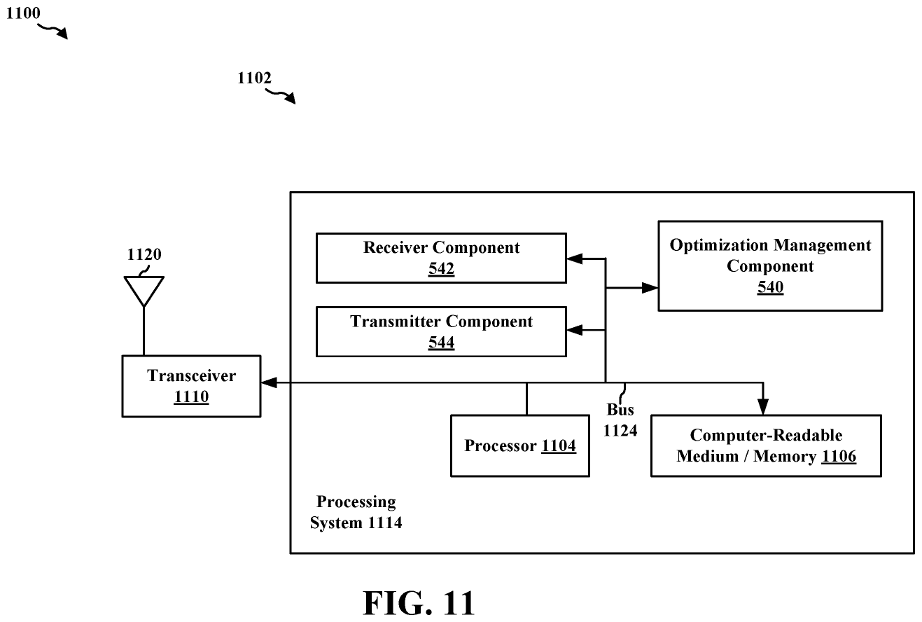

In addition, the network entity 502 may include a receiver component 542 and a transmitter component 544. The receiver component 542 may include, for example, a radio frequency (RF) receiver for receiving the signals described herein. The transmitter component 544 may include, for example, an RF transmitter for transmitting the signals described herein. In an aspect, the receiver component 522 and the transmitter component 544 may be co-located in a transceiver (e.g., the transceiver 1110 shown in FIG. 11).

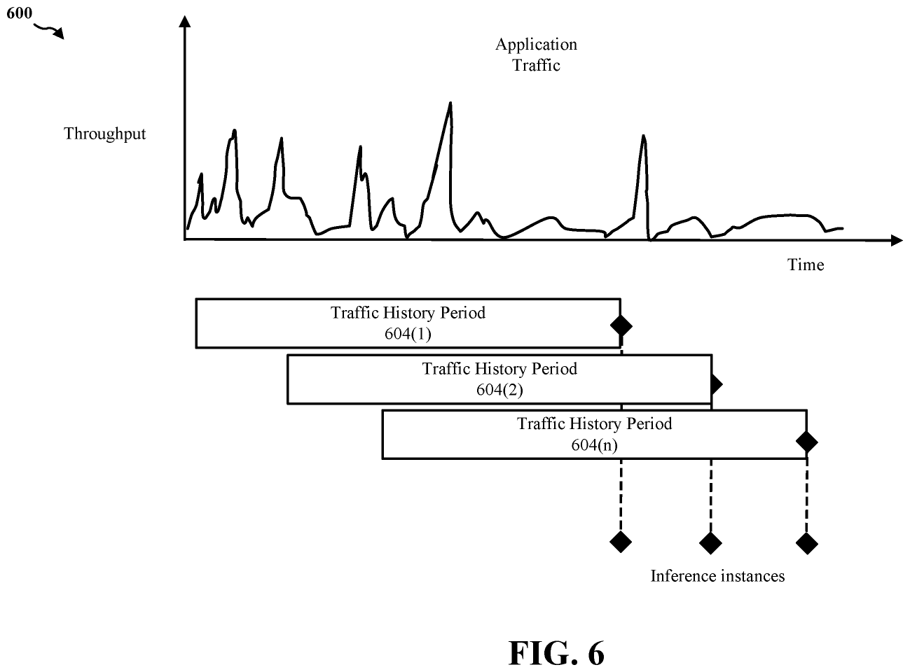

FIG. 6 is a diagram 600 illustrating an example of application traffic collection, in accordance with some aspects of the present disclosure. As illustrated in in FIG. 6, application traffic 602 may be transmitted and received by a UE, e.g., the UE 504(1). Further, the UE may collect the application traffic 602 as traffic history periods 604(1)-(n). Further as illustrated in FIG. 6, at the end of a traffic history period 604 (i.e., the inference instances 606(1)-(n)), the UE may categorize the application traffic of the traffic history period 604 using the categorization component 140. In addition, as illustrated in FIG. 6, the application traffic 602 corresponding to a first traffic history period 604 may partially overlap with the application traffic 602 corresponding to another traffic history period (e.g., the 2^{nd} traffic history period 604(2)), and so forth.

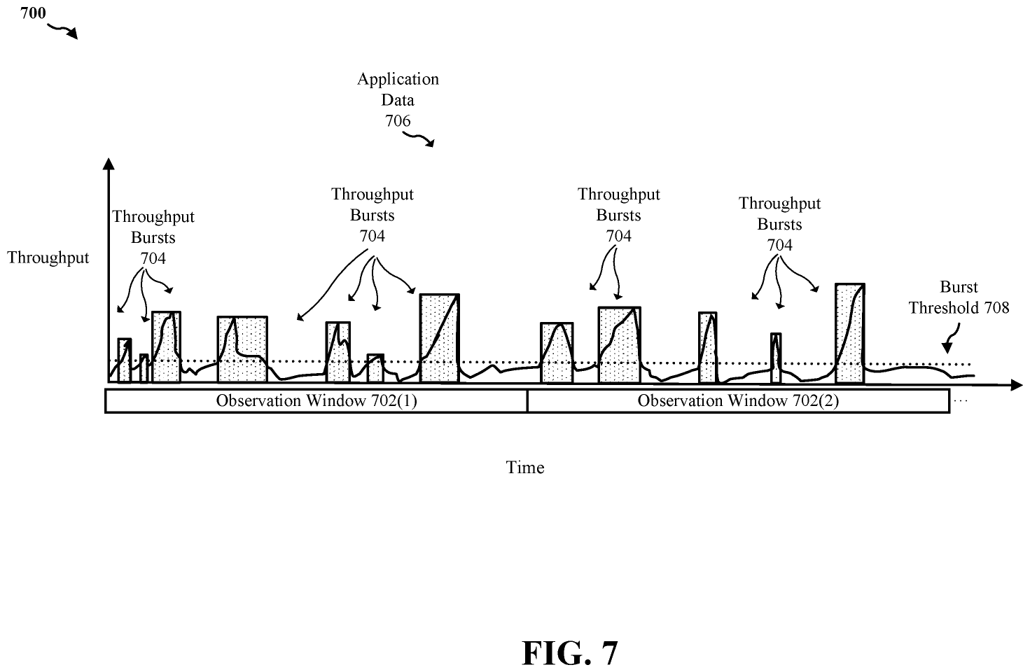

FIG. 7 is a diagram 700 illustrating an example of throughput bursts within observation periods, in accordance with some aspects of the present disclosure. As illustrated in FIG. 7, the application traffic of a traffic history period may be averaged and split into one or more observation windows 702(1)-(n). Further, the burst detection component 516 of a UE (e.g., the UE 504(1)) may detect throughput bursts 704 within the observation windows 702(1)-(n) based on the throughput of the application data 706 during the observation windows 702(1)-(n) being greater than a burst threshold 708.

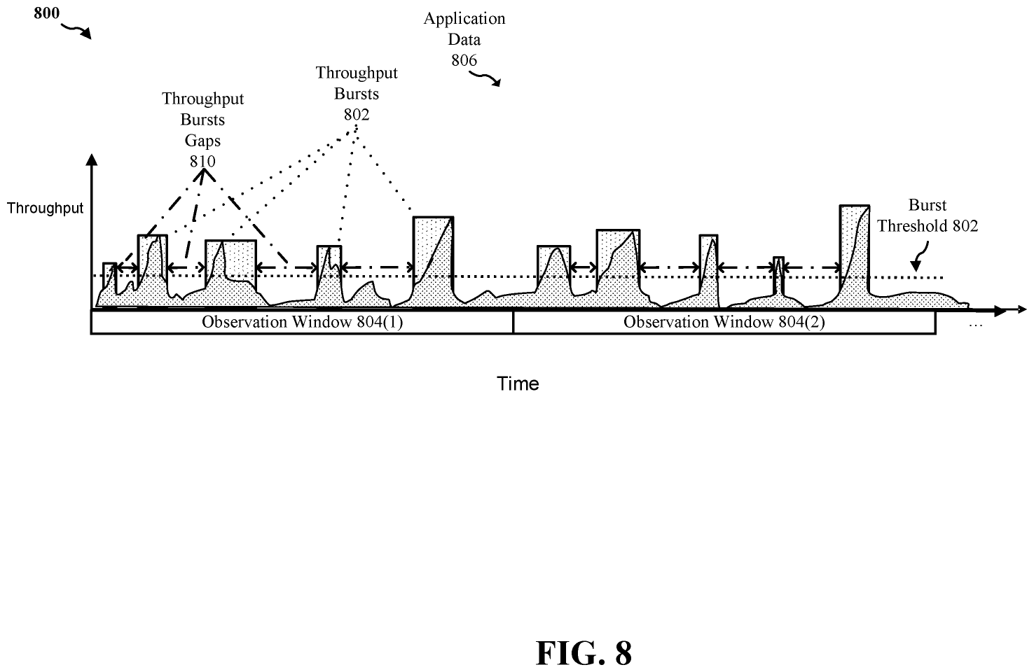

FIG. 8 is a diagram 800 illustrating an example of throughput burst gaps within observation periods, in accordance with some aspects of the present disclosure. As illustrated in FIG. 8, the burst detection component 516 of a UE (e.g., the UE 504(1)) may detect throughput bursts 802 within the observation windows 804(1)-(n) based on the throughput of the application data 806 during the observation windows 804(1)-(n) being greater than a burst threshold 808. Further, as illustrated in FIG. 8, burst gaps 810 may exist between the throughput bursts 802.

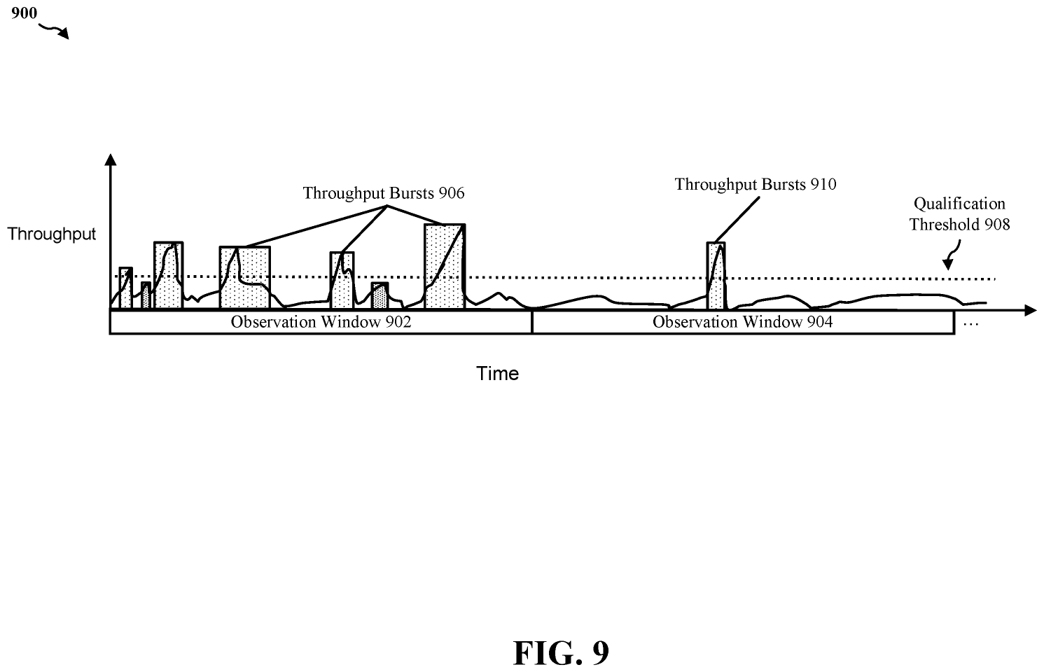

FIG. 9 is a diagram 900 illustrating an example of qualified throughput bursts within observation periods, in accordance with some aspects of the present disclosure. As illustrated in FIG. 9, the qualification component 518 may determine that a first observation window 902 is qualified and a second observation window 904 is not qualified. For example, the qualification component 518 may determine that the first observation window 902 is qualified based on the number of throughput bursts 906 within the observation window 902 that are greater than a qualification threshold 908 being greater than a predefined amount. Further, the qualification component 518 may determine that the second observation window 904 is not qualified based on the number of throughput bursts 910 within the observation window 902 that are greater than a qualification threshold 908 being less than the predefined amount.

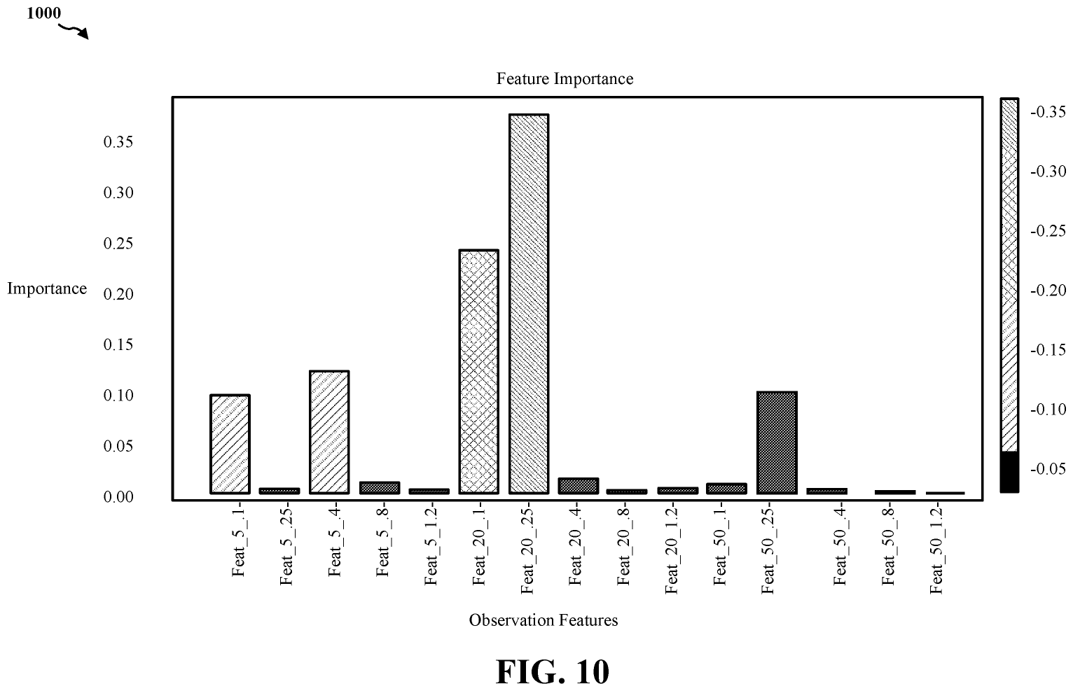

FIG. 10 is a bar graph 1000 illustrating an example of one or more features downselected based on feature importance, in accordance with some aspects of the present disclosure. For example, in some aspects, a feature selection ML model (e.g., the feature selection ML model 524(2)) may determine the importance of a plurality of observation features. In addition, the feature selection ML model may downselect the observation features by reducing the observation features used during an inference phase to the observation features having an importance greater than a predefined threshold.

FIG. 11 is a diagram 1100 illustrating an example of a hardware implementation for a network entity 1102 employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware components, represented by the processor 1104, the optimization management component 540, and the computer-readable medium/memory 1106. The bus 1124 may also link various other circuits such as timing sources, peripherals, voltage regulators, and power management circuits, which are well known in the art, and therefore, will not be described any further.

The processing system 1114 may be coupled with a transceiver 1110. The transceiver 1110 is coupled with one or more antennas 1120. The transceiver 1110 provides a means for communicating with various other apparatus over a transmission medium. The transceiver 1110 receives a signal from the one or more antennas 1120, extracts information from the received signal, and provides the extracted information to the processing system 1114, specifically the receiver component 542. The receiver component 542 may receive the application traffic 506 and the optimization requests 536. In addition, the transceiver 1110 receives information from the processing system 1114, specifically the transmitter component 544, and based on the received information, generates a signal to be applied to the one or more antennas 1120. Further, the transmitter component 544 may send the application traffic 506 and the optimization responses 538.

The processing system 1114 includes a processor 1104 coupled with a computer-readable medium/memory 1106 (e.g., a non-transitory computer readable medium). The processor 1104 is responsible for general processing, including the execution of software stored on the computer-readable medium/memory 1106. The software, when executed by the processor 1104, causes the processing system 1114 to perform the various functions described supra for any particular apparatus. The computer-readable medium/memory 1106 may also be used for storing data that is manipulated by the processor 1104 when executing software. The processing system 1114 further includes the optimization management component 540. The aforementioned components may be software components running in the processor 1104, resident/stored in the computer readable medium/memory 1106, one or more hardware components coupled with the processor 1104, or some combination thereof. The processing system 1114 may be a component of the base station 310 and may include the memory 376 and/or at least one of the TX processor 316, the RX processor 370, and the controller/processor 375. Alternatively, the processing system 1114 may be the entire base station (e.g., see 310 of FIG. 3, network entity 502 of FIG. 5).

The aforementioned means may be one or more of the aforementioned components of the network entity 1102 and/or the processing system 1114 of the network entity 1102 configured to perform the functions recited by the aforementioned means. As described supra, the processing system 1114 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

FIG. 12 is a diagram 1200 illustrating an example of a hardware implementation for a device 1202 (e.g., the UE 104, the UE 504, etc.) employing a processing system 1214. The processing system 1214 may be implemented with a bus architecture, represented generally by the bus 1224. The bus 1224 may include any number of interconnecting buses and/or bridges depending on the specific application of the processing system 1214 and the overall design constraints. The bus 1224 links together various circuits including one or more processors and/or hardware components, represented by the processor 1204, the categorization component 140, the collection component 514, the burst detection component 516, the qualification component 518, the observation component 520, the scheduling component 522, the one or more ML models 524(1)-(n), the traffic management component 526, and the computer-readable medium (e.g., non-transitory computer-readable medium)/memory 1206. The bus 1224 may also link various other circuits such as timing sources, peripherals, voltage regulators, and power management circuits, which are well known in the art, and therefore, will not be described any further.

The processing system 1214 may be coupled with a transceiver 1210. The transceiver 1210 may be coupled with one or more antennas 1220. The transceiver 1210 provides a means for communicating with various other apparatus over a transmission medium. The transceiver 1210 receives a signal from the one or more antennas, extracts information from the received signal, and provides the extracted information to the processing system 1214, specifically the receiver component 528. The receiver component 528 may receive the application traffic 506 and the optimization responses 538. In addition, the transceiver 1210 receives information from the processing system 1214, specifically the transmitter component 530, and based on the received information, generates a signal to be applied to the one or more antennas. Further, the transmitter component 530 may application traffic 506 and the optimization requests 536.

The processing system 1214 includes a processor 1204 coupled with a computer-readable medium/memory 1206 (e.g., a non-transitory computer readable medium). The processor 1204 is responsible for general processing, including the execution of software stored on the computer-readable medium/memory 1206. The software, when executed by the processor 1204, causes the processing system 1214 to perform the various functions described supra for any particular apparatus. The computer-readable medium/memory 1206 may also be used for storing data that is manipulated by the processor 1204 when executing software. The processing system 1214 further includes at least one of the application(s) 508(1)-(n), the categorization component 140, the collection component 514, the burst detection component 516, the qualification component 518, the observation component 520, the scheduling component 522, the one or more ML models 524(1)-(n), and the traffic management component 526. The aforementioned components may be a software component running in the processor 1204, resident/stored in the computer readable medium/memory 1206, one or more hardware components coupled with the processor 1204, or some combination thereof. The processing system 1214 may be a component of the device 1202 and may include the memory 360 and/or at least one of the TX processor 368, the RX processor 356, and the controller/processor 359. Alternatively, the processing system 1214 may be the entire UE (e.g., see 350 of FIG. 3, UE 504 of FIG. 5).

The aforementioned means may be one or more of the aforementioned components of the device 1202 and/or the processing system 1214 of device 1202 configured to perform the functions recited by the aforementioned means. As described supra, the processing system 1214 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

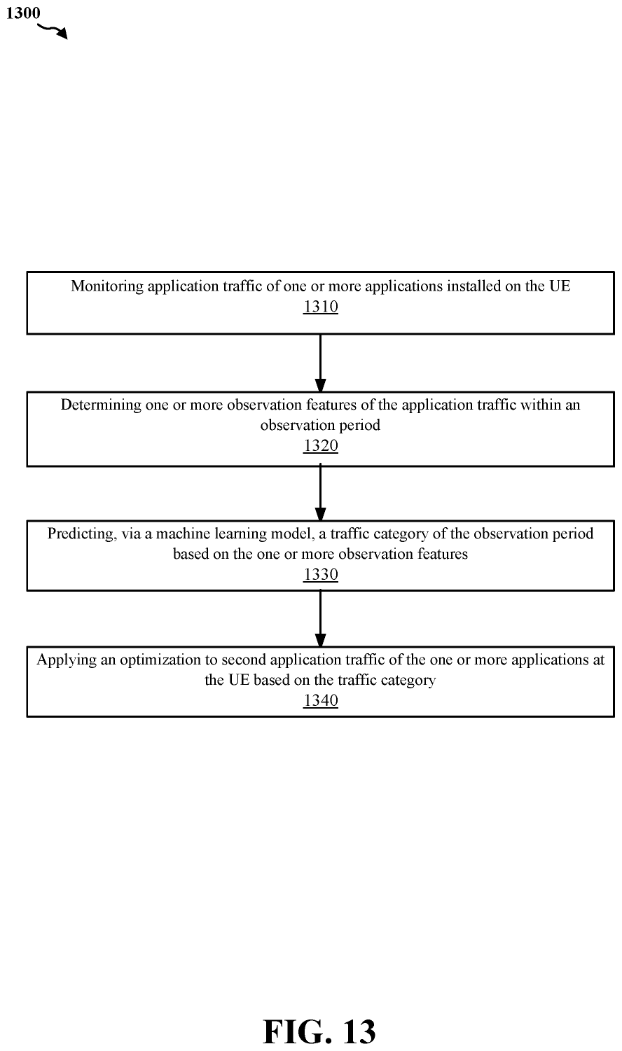

FIG. 13 is a flowchart of an example method of flow-based traffic categorization for device optimization, in accordance with some aspects of the present disclosure. The method may be performed by a UE (e.g., the UE 104 of FIGS. 1 and 3, which may include the memory 360 and which may be the entire UE 104 or a component of the UE 104, such as the categorization component 140, the collection component 514, the burst detection component 516, the qualification component 518, the observation component 520, the scheduling component 522, the one or more ML models 524(1)-(n), the traffic management component 526, the TX processor 368, the RX processor 356, and/or the controller/processor 359; the UE 504 of FIG. 5; and/or the device 1202 of FIG. 12).

At block 1310, the method 1300 may include monitoring application traffic of one or more applications installed on the UE. For example, the UE 504(1) may monitor application traffic 602 of one or more applications 508(1)-(n) installed on the UE 504(1).

Accordingly, the UE 104, the UE 504, device 1202, the TX processor 368, the RX processor 356, and/or the controller/processor 359, executing the categorization component 140 may provide means for monitoring application traffic of one or more applications installed on the UE.

At block 1320, the method 1300 may include determining one or more observation features of the application traffic within an observation period. For example, the observation component 520 may determine one or more observation features 534(1)-(n) for the observation periods.

Accordingly, the UE 104, the UE 504, device 1202, the TX processor 368, the RX processor 356, and/or the controller/processor 359 executing the categorization component 140 and/or the one or more ML models 524(1)-(n) may provide means for determining one or more observation features of the application traffic within an observation period.

At block 1330, the method 1300 may include predicting, via a machine learning model, a traffic category of the observation period based on the one or more observation features. For example, the inference ML model 524(1) may categorize the application traffic 506 based on the observation features 534(1)-(n) determined for the different plurality of observation window size and burst threshold pairs during an inference phase.

Accordingly, the UE 104, the UE 504, device 1202, the TX processor 368, the RX processor 356, and/or the controller/processor 359 executing the categorization component 140 and/or the one or more ML models 524(1)-(n) may provide means for predicting, via a machine learning model, a traffic category of the observation period based on the one or more observation features.

At block 1340, the method 1300 may include applying an optimization to second application traffic of the one or more applications at the UE based on the traffic category. For example, the traffic management component 526 may modify the operation of the UE 504(1) based on the category predicted by the ML model 524(1). For example, the inference ML model 524 may determine the application traffic is streaming video, and the traffic management component 526 may optimize operation of the UE 504(1) for video streaming traffic.

Accordingly, the UE 104, the UE 504, device 1202, the TX processor 368, the RX processor 356, and/or the controller/processor 359 executing categorization component 140 and/or the traffic management component 526 may provide means for applying an optimization to second application traffic of the one or more applications at the UE based on the traffic category.

The previous description is provided to enable any person having ordinary skill in the art to practice the various aspects described herein. Various modifications to these aspects will be readily apparent to a person having ordinary skill in the art, and the generic principles defined herein may be applied to other aspects. The claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to a person having ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### Example Clauses

The following example clauses describe various aspects of the present disclosure.
A. A method for wireless communication at a User equipment comprising: monitoring application traffic of one or more applications installed on the UE; determining one or more observation features of the application traffic within an observation period; predicting, via a machine learning (ML) model, a traffic category of the observation period based on the one or more observation features; and applying an optimization to second application traffic of the one or more applications at the UE based on the traffic category.
B. The method of clause A, wherein predicting the traffic category based on the one or more observation features, comprises: determining traffic volume information for the application traffic during the observation period; determining that the traffic volume information meets a predetermined criteria; and predicting the traffic category in response to the traffic volume information meeting the predetermined criteria.
C. The method of any of clauses A-B, wherein the observation period is a first observation period, the one or more observation features are one or more first observation features, the traffic category is a first traffic category, and further comprising: determining traffic volume information for the application traffic during a second observation period; determining that the traffic volume information fails to meet a predetermined criteria; and skipping prediction of a second traffic category in response to the traffic volume information failing to meet the predetermined criteria.
D. The method of any of clauses A-C, wherein determining the one or more observation features of the application traffic within the observation period, comprising: identifying one or more throughput bursts within the observation period based on a plurality of observation window size and burst threshold pairs; and determining the one or more observation features based on the one or more throughput bursts.
E. The method of any of clauses A-D, wherein the notification identifies at least one of an application context of the application client or a device context of the UE.
F. The method of any of clauses A-E, wherein identifying the one or more throughput bursts within the observation period based on the plurality of observation window size and burst threshold pairs comprises: determining that throughput of the application traffic is greater than a burst threshold within an observation window size, wherein the burst threshold and the observation window size are an observation window size
   burst threshold pair of the plurality of observation window size and burst threshold pairs.
G. The method of any of clauses A-F, wherein applying the optimization comprises: transmitting, to a network entity, a network configuration request based on the optimization; receiving, from the network entity, a configuration indication in response to the network configuration request; and transmitting the second application traffic in accordance with the optimization in response to the configuration indication.
H. The method of any of clauses A-F, herein applying the optimization comprises at least one of: modifying one or more CDRX attributes; implementing a low latency mode; deactivating one or more antennas of the UE; reducing the internal processors or DSP clock speed; or implementing traffic prioritization.
I. The method of any of clauses A-H, wherein the ML model is a first ML model, the one or more observation features are a second plurality of a plurality of observation window size and burst threshold pairs, and further comprising downselecting, using a second ML during a training phase of the first ML model, from a first plurality of observation window size and burst threshold pairs to the second plurality of a plurality of observation window size and burst threshold pairs.
J. The method of any of clauses A-I, wherein the one or more observation features include throughput bursts per minute, throughput burst occupancy, throughput burst volume percentage, throughput burst volume standard deviation, throughput burst gap standard deviation, or downlink volume ratio.
K. One or more non-transitory computer-readable media encoded with instructions that, when executed by one or more processors, configure a computing device to perform a computer-implemented method as any of clauses A-J recite.
L. A device comprising one or more processors and one or more computer-readable media encoded with instructions that, when executed by the one or more processors, configure a computer to perform a computer-implemented method as any of clauses A-J recite.
M. A device, comprising means for performing the method of any of clauses A-J.

What is claimed is:

1. A method of wireless communication at a user equipment (UE), comprising:
monitoring application traffic of one or more applications installed on the UE;
determining one or more observation features of the application traffic within an observation period;
predicting, via a machine learning (ML) model, a traffic category of the observation period based on the one or more observation features; and
applying an optimization to second application traffic of the one or more applications at the UE based on the traffic category.

2. The method of claim 1, wherein predicting the traffic category based on the one or more observation features, comprises:
determining traffic volume information for the application traffic during the observation period;
determining that the traffic volume information meets a predetermined criteria; and
predicting the traffic category in response to the traffic volume information meeting the predetermined criteria.

3. The method of claim 1, wherein the observation period is a first observation period, the one or more observation features are one or more first observation features, the traffic category is a first traffic category, and further comprising:
determining traffic volume information for the application traffic during a second observation period;
determining that the traffic volume information fails to meet a predetermined criteria; and
skipping prediction of a second traffic category in response to the traffic volume information failing to meet the predetermined criteria.

4. The method of claim 1, wherein determining the one or more observation features of the application traffic within the observation period, comprising:
identifying one or more throughput bursts within the observation period based on a plurality of observation window size and burst threshold pairs; and
determining the one or more observation features based on the one or more throughput bursts.

5. The method of claim 4, wherein identifying the one or more throughput bursts within the observation period based on the plurality of observation window size and burst threshold pairs comprises:
determining that throughput of the application traffic is greater than a burst threshold within an observation window size, wherein the burst threshold and the observation window size are an observation window size-burst threshold pair of the plurality of observation window size and burst threshold pairs.

6. The method of claim 1, wherein applying the optimization comprises:
transmitting, to a network entity, a network configuration request based on the optimization;
receiving, from the network entity, a configuration indication in response to the network configuration request; and
transmitting the second application traffic in accordance with the optimization in response to the configuration indication.

7. The method of claim 1, wherein applying the optimization comprises at least one of:
modifying one or more CDRX attributes;
implementing a low latency mode;
deactivating one or more antennas of the UE;
reducing the internal processors or DSP clock speed; or
implementing traffic prioritization.

8. The method of claim 1, wherein the ML model is a first ML model, the one or more observation features are a second plurality of a plurality of observation window size and burst threshold pairs, and further comprising downselecting, using a second ML during a training phase of the first ML model, from a first plurality of observation window size and burst threshold pairs to the second plurality of a plurality of observation window size and burst threshold pairs.

9. The method of claim 1, wherein the one or more observation features include throughput bursts per minute, throughput burst occupancy, throughput burst volume percentage, throughput burst volume standard deviation, throughput burst gap standard deviation, or downlink volume ratio.

10. A user equipment (UE) for wireless communication, comprising:
a memory storing computer-executable instructions; and
at least one processor coupled with the memory and configured to execute the computer-executable instructions to:
monitor application traffic of one or more applications installed on the UE;
determine one or more observation features of the application traffic within an observation period;
predict, via a machine learning (ML) model, a traffic category of the observation period based on the one or more observation features; and
apply an optimization to second application traffic of the one or more applications at the UE based on the traffic category.

11. The UE of claim 10, wherein to predict the traffic category based on the one or more observation features, the at least one processor is further configured to execute the computer-executable instructions to:
determine traffic volume information for the application traffic during the observation period;
determine that the traffic volume information meets a predetermined criteria; and
predict the traffic category in response to the traffic volume information meets the predetermined criteria.

12. The UE of claim 10, wherein the observation period is a first observation period, the one or more observation features are one or more first observation features, the traffic category is a first traffic category, and the at least one processor is further configured to execute the computer-executable instructions to:
determine traffic volume information for the application traffic during a second observation period;
determine that the traffic volume information fails to meet a predetermined criteria; and
skip prediction of a second traffic category in response to the traffic volume information failing to meet the predetermined criteria.

13. The UE of claim 10, wherein to determine the one or more observation features of the application traffic within the observation period, the at least one processor is further configured to execute the computer-executable instructions to:
identify one or more throughput bursts within the observation period based on a plurality of observation window size and burst threshold pairs; and
determine the one or more observation features based on the one or more bursts.

14. The UE of claim 13, wherein to identify the one or more throughput bursts within the observation period based on the plurality of observation window size and burst threshold pairs, the at least one processor is further configured to execute the computer-executable instructions to:
determine that throughput of the application traffic is greater than a burst threshold within an observation window size, wherein the burst threshold and the observation window size are an observation window size-burst threshold pair of the plurality of observation window size and burst threshold pairs.

15. The UE of claim 10, wherein to apply the optimization, the at least one processor is further configured to execute the computer-executable instructions to:
transmit, to a network entity, a network configuration request based on the optimization;
receive, from the network entity, a configuration indication in response to the network configuration request; and
transmit the second application traffic in accordance with the optimization in response to the configuration indication.

16. The UE of claim 10, wherein to apply the optimization, the at least one processor is further configured to execute the computer-executable instructions to:
modifying one or more CDRX attributes;
implementing a low latency mode;
deactivating one or more antennas of the UE;
reducing the internal processors or DSP clock speed; or
implementing traffic prioritization.

17. The UE of claim 10, wherein the ML model is a first ML model, the one or more observations are a second plurality of a plurality of observation window size and burst threshold pairs, and the at least one processor is further configured to execute the computer-executable instructions to:
downselect, using a second ML during a training phase of the first ML model, from a first plurality of observation window size and burst threshold pairs to the second plurality of a plurality of observation window size and burst threshold pairs.

18. The UE of claim 10, wherein the one or more observation features include bursts per minute, burst occupancy, burst volume percentage, burst volume standard deviation, burst gap standard deviation, or downlink volume ratio.

19. A non-transitory computer-readable device having instructions thereon that, when executed by at least one computing device, causes the at least one computing device to perform operations comprising:
monitoring application traffic of one or more applications;
determining one or more observation features of the application traffic within an observation period;
predicting, via a machine learning (ML) model, a traffic category of the observation period based on the one or more observation features; and
applying an optimization to second application traffic of the one or more applications based on the traffic category.

20. The non-transitory computer-readable device of claim 19, wherein predicting the traffic category based on the one or more observation features, and the operations further comprise:
determining traffic volume information for the application traffic during the observation period;
determining that the traffic volume information meets a predetermined criteria; and
predicting the traffic category in response to the traffic volume information meets the predetermined criteria.

21. The non-transitory computer-readable device of claim 19, wherein the observation period is a first observation period, the one or more observation features are one or more first observation features, the traffic category is a first traffic category, and the operations further comprise:
determining traffic volume information for the application traffic during a second observation period;
determining that the traffic volume information fails to meet a predetermined criteria; and
skipping prediction of a second traffic category in response to the traffic volume information failing to meet the predetermined criteria.

22. The non-transitory computer-readable device of claim 19, wherein determining the one or more observation features of the application traffic within the observation period comprises:
identifying one or more throughput bursts within the observation period based on a plurality of observation window size and burst threshold pairs; and
determining the one or more observation features based on the one or more bursts.

23. The non-transitory computer-readable device of claim 22, wherein identifying the one or more throughput bursts within the observation period based on the plurality of observation window size and burst threshold pairs comprises:
determining that throughput of the application traffic is greater than a burst threshold within an observation window size, wherein the burst threshold and the observation window size are an observation window size-burst threshold pair of the plurality of observation window size and burst threshold pairs.

24. The non-transitory computer-readable device of claim 19, wherein applying the optimization comprises:
transmitting, to a network entity, a network configuration request based on the optimization;
receiving, from the network entity, a configuration indication in response to the network configuration request; and
transmitting the second application traffic in accordance with the optimization in response to the configuration indication.

25. The non-transitory computer-readable device of claim 19, wherein applying the optimization comprises at least one of:
modifying one or more CDRX attributes;
implementing a low latency mode;
deactivating one or more antennas;
reducing the internal processors or DSP clock speed; or
implementing traffic prioritization.

26. The non-transitory computer-readable device of claim 19, wherein the ML model is a first ML model, the one or more observations are a second plurality of a plurality of observation window size and burst threshold pairs, and further comprising downselecting, using a second ML during a training phase of the first ML model, from a first plurality of observation window size and burst threshold pairs to the second plurality of a plurality of observation window size and burst threshold pairs.

27. The non-transitory computer-readable device of claim 19, wherein the one or more observation features include bursts per minute, burst occupancy, burst volume percentage, burst volume standard deviation, burst gap standard deviation, or downlink volume ratio.

28. A user equipment (UE) for wireless communication, comprising:
means for monitoring application traffic of one or more applications installed on the UE;
means for determining one or more observation features of the application traffic within an observation period;
means for predicting, via a machine learning model, a traffic category of the observation period based on the one or more observation features; and
means for applying an optimization to second application traffic of the one or more applications at the UE based on the traffic category.

29. The UE of claim 28, wherein the observation period is a first observation period, the one or more observation features are one or more first observation features, the traffic category is a first traffic category, and the at least one processor is further configured to execute the computer-executable instructions to:
means for determining traffic volume information for the application traffic during a second observation period;
means for determining that the traffic volume information fails to meet a predetermined criteria; and
means for skipping prediction of a second traffic category in response to the traffic volume information failing to meet the predetermined criteria.

30. The UE of claim 28, wherein the one or more observation features include bursts per minute, burst occupancy, burst volume percentage, burst volume standard deviation, burst gap standard deviation, or downlink volume ratio.
